(19) United States
(12) Patent Application Publication
(10) Pub. No.: US 2014/0159327 A1
(43) Pub. Date: Jun. 12, 2014

(54) Shopping Cart

(71) Applicant: Unarco Industries LLC, Wagoner, OK (US)

(72) Inventors: Woody Smith, Stillwater, OK (US); Wesley McMurtrey, Wagoner, OK (US)

(73) Assignee: Unarco Industries LLC, Wagoner, OK (US)

(21) Appl. No.: 14/098,744

(22) Filed: Dec. 6, 2013

Related U.S. Application Data
(60) Provisional application No. 61/734,275, filed on Dec. 6, 2012.

(51) Int. Cl. B62B 3/02

(52) U.S. Cl. CPC B62B 3/027
USPC 280/33.991

(57) ABSTRACT

A shopping cart includes a handle with a basket attached to the handle. A frame is attached to the handle and includes opposing sections. Each of the opposing sections of the frame include a first tier portion, a second tier portion and an inclined portion positioned between the first and second tier portions so that a caster lift is formed. A number of casters are attached to the frame. A cross wire is attached to the frame and is adopted to engage a caster lift of a second cart.

### CLAIM OF PRIORITY

This application claims priority to U.S. Provisional Patent Application No. 61/734,275, filed Dec. 6, 2012, the contents of which are hereby incorporated by reference.

### FIELD OF THE INVENTION

The present invention relates generally to shopping carts and, in particular, to a shopping cart that includes a rear caster lift, that may nest with dissimilar carts and that is economical to construct.

### BRIEF DESCRIPTION OF THE DRAWINGS

FIG. 1 is a perspective view of a first embodiment of the shopping cart of the present invention;

FIG. 2 is a front elevational view of the cart of FIG. 1

FIG. 3 is a side elevational view of the cart of FIGS. 1 and 2

FIG. 4 is a perspective view of a the shopping cart of FIGS. 1-3 nested with a second shopping cart of the same construction;

FIG. 5 is a perspective view of the shopping cart of FIGS. 1-3 nested with a second shopping cart featuring a different construction;

FIG. 6 is an enlarged, partial perspective view of the portion of the cart of FIG. 5 indicated by circle 6;

FIG. 7 is an enlarged perspective view of a portion of the frame and handle of the cart of FIG. 1;

FIG. 8 is perspective view of a second embodiment of the shopping cart of the present invention.

### DETAILED DESCRIPTION OF EMBODIMENTS

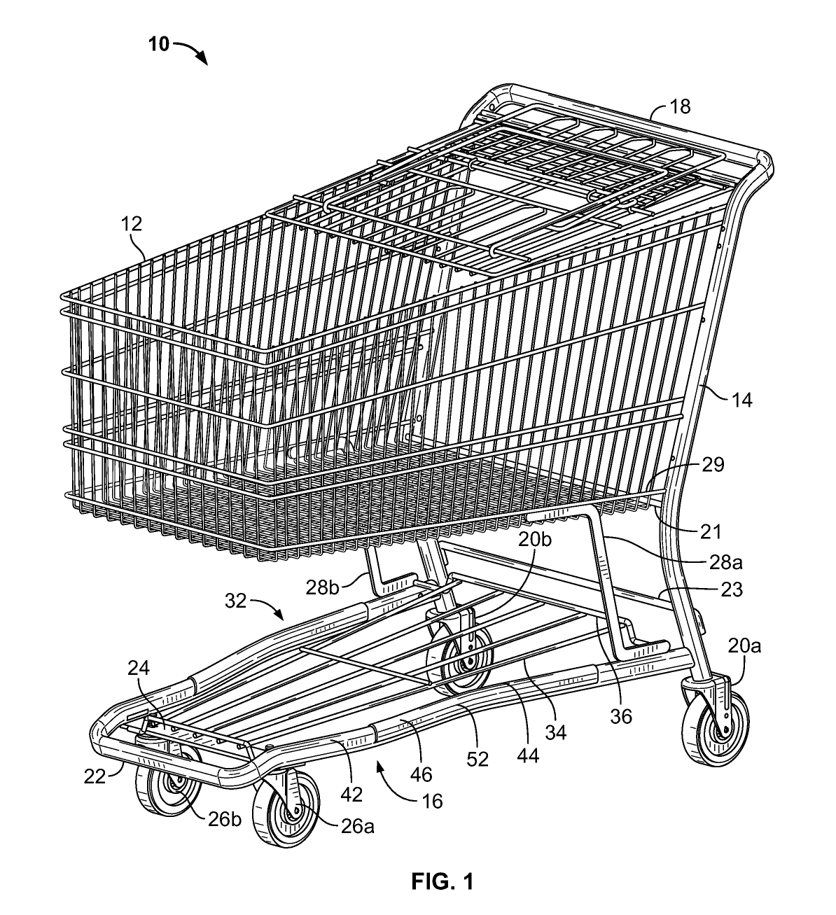

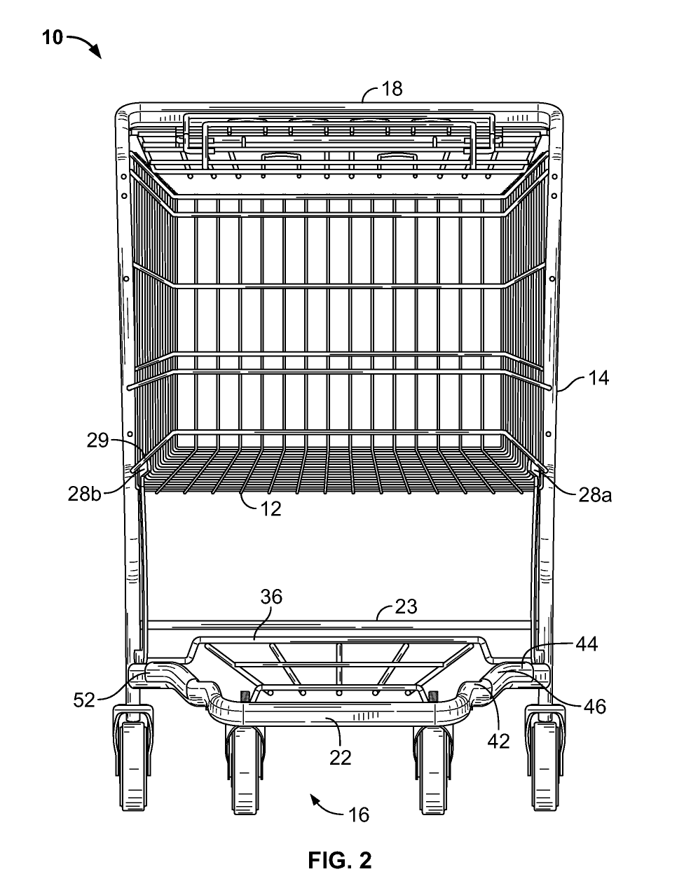

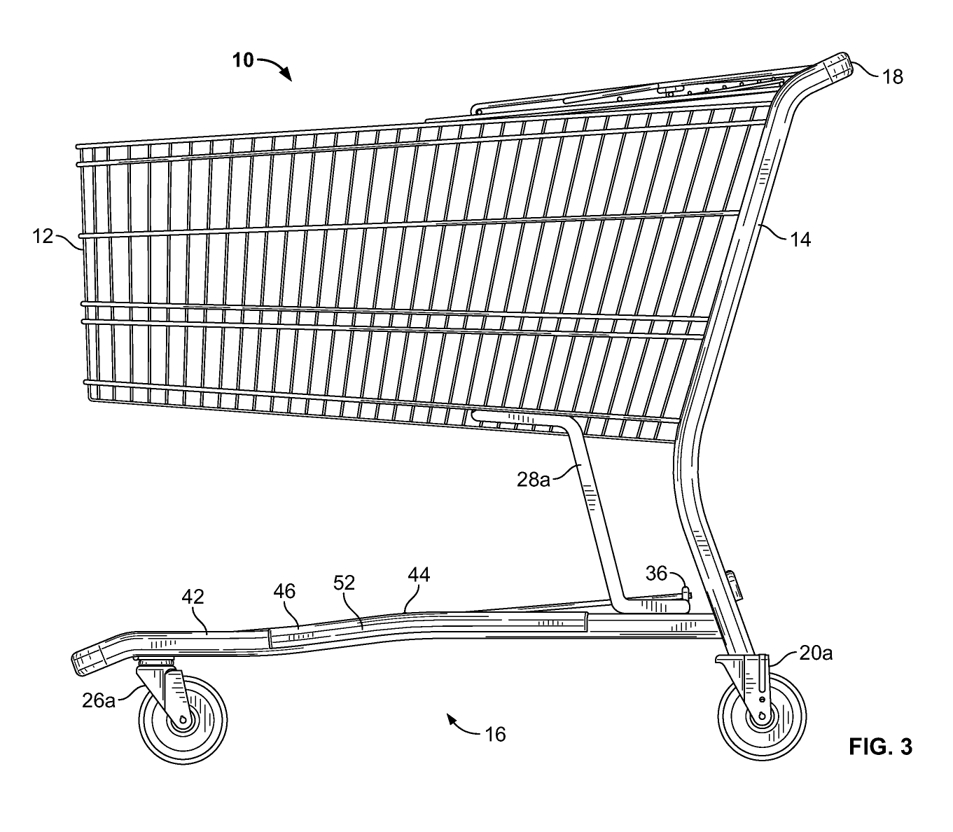

A first embodiment of the shopping cart of the present invention is indicated in general at 10 in FIGS. 1-3. The cart includes a basket 12, preferably featuring a conventional metal wire construction. The cart also includes a handle 14 and a frame 16.

The handle features a generally inverted or upside-down U-shape so that a gripping portion 18 is formed at the top. A pair of rear casters 20a and 20b are attached to the bottom ends of the handle 14. A rod 21 and a bar 23 extend between opposing sections of the handle 14.

The trailing edges of sidewalls of the basket 12 are secured to the opposing sections of the handle 14, such as by welding or other fastening arrangements known in the art, while the trailing edge of the basket floor is secured to rod 21.

The frame 16 generally features a V-shape so that nose 22 is formed and the frame tapers to a narrower dimension towards the nose. A front caster strip 24 is secured to and traverses the space between opposing sections of the frame near the nose 22 so that front casters 26a and 26b may be attached. The trailing ends of the frame 16 are connected to the handle 14, such as by welding. A pair of generally Z-shaped supports 28a and 28b are attached to the bottom of a generally horizontal wire 29 of the basket and to the frame 16, such as by welding, to aid in supporting the basket 12.

A lower shelf, indicated in general at 32, is formed by a number of longitudinal wires 34, attached by their leading ends to front caster strip 24. A cross wire 36, the functionality of which will be explained below, is attached across the ends of the longitudinal wires 34 and to the Z-shaped supports 28a and 28b.

As illustrated in FIGS. 1-3, the frame 16 of the cart 10 incorporates a rear caster lift for when the cart is nested with carts featuring the same construction. More specifically, as illustrated in FIGS. 1-3, the frame 16 generally features a step construction with a first or leading tier portion 42 and a higher trailing or second tier portion 44 with an inclined portion 46 connecting the two. The inclined portion 46 and the second tier portion 44 are preferably provided with a cover 52 to protect the frame from damage during nesting, as will be apparent from the following. The cover 52 may be constructed from steel, plastic, rubber or any other durable material and may be secured in place with adhesive or fasteners.

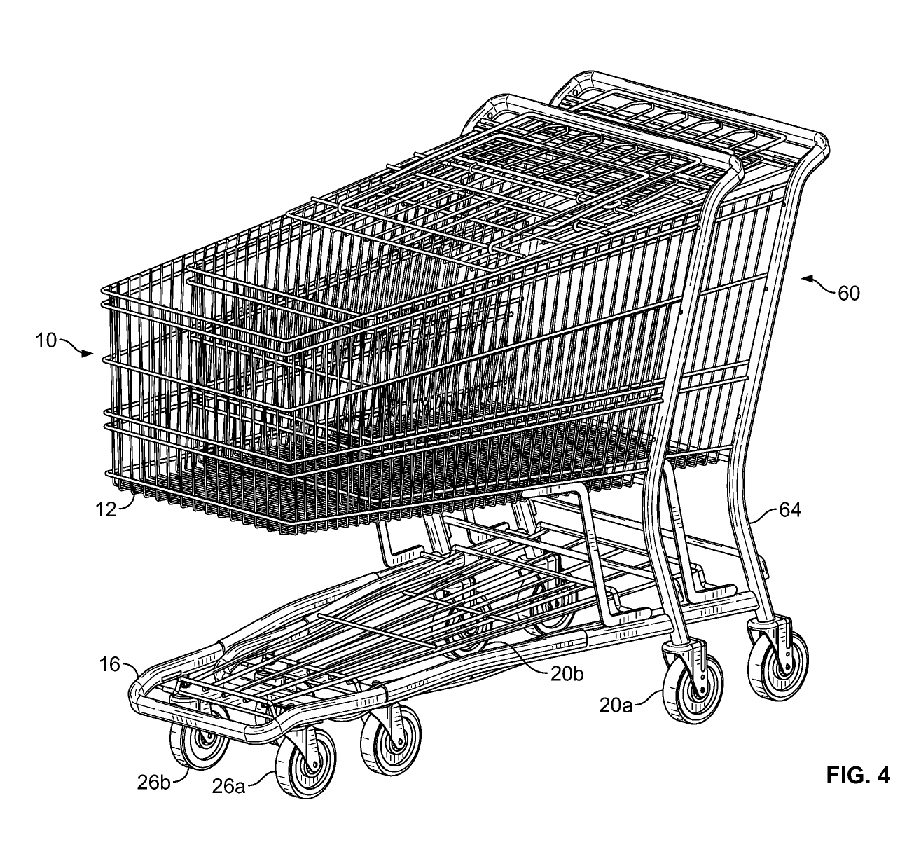

FIG. 4 illustrates the situation when the cart of FIGS. 1-3 is nested with a cart of a similar construction. During the initial portion of the nesting process, the V-shape of the frames of the carts causes the nose of the rearmost cart 60 to pass between the opposing sections of the handle (illustrated at 64 for the rearmost cart 60 in FIG. 4). The inclined portion and the second tier portion, and thus the covers over same, of the caster lift of the frame of the rearmost cart 60 then travel beneath the inclined portion 46 and second tier portion 44 of the front cart 10 so as to lift the rear casters 20a and 20b of the front cart off of the ground.

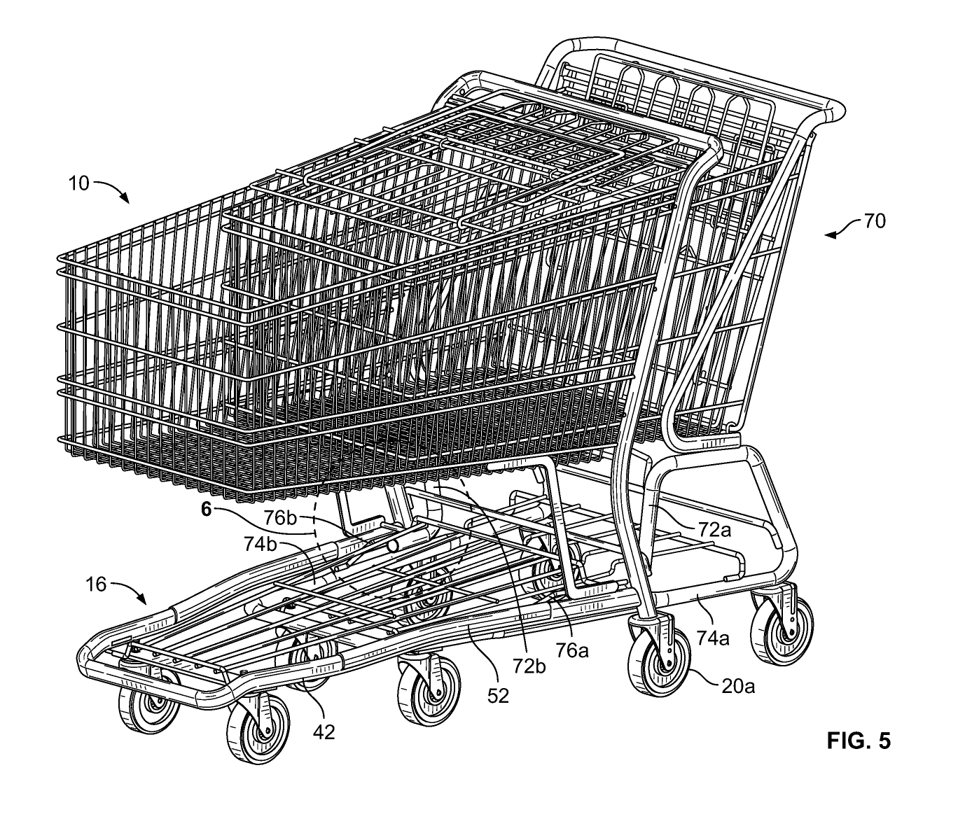

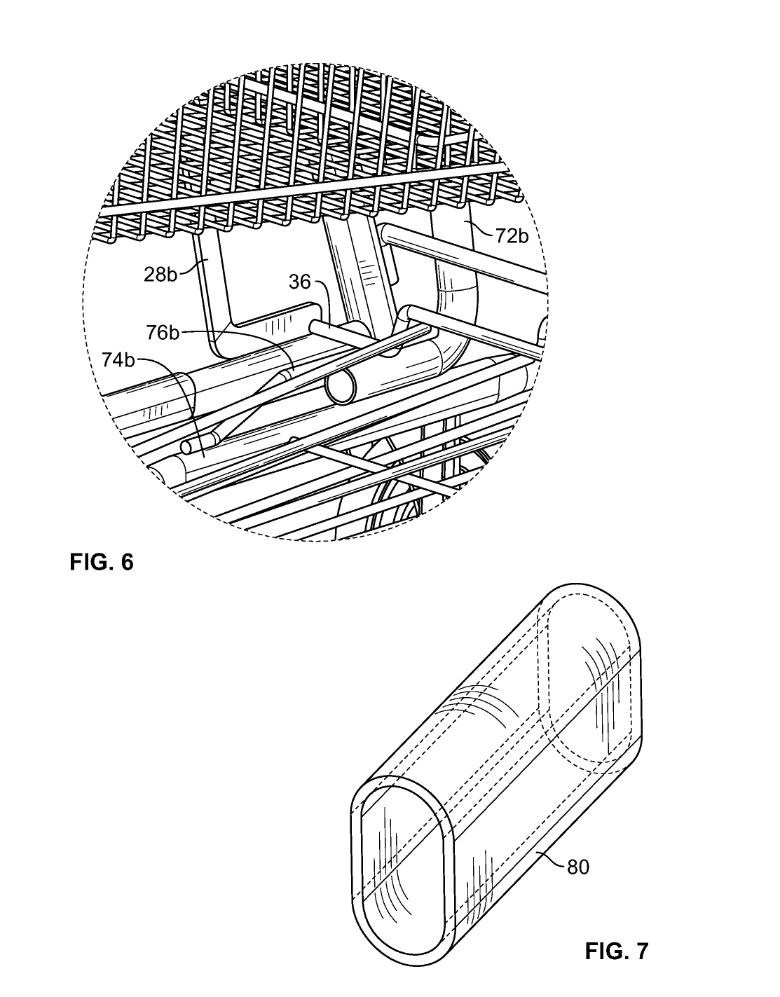

The cart of FIGS. 1-3 may be nested with carts featuring a different construction, such as cart 70 of FIGS. 5 and 6. As illustrated in FIGS. 5 and 6, the cart 70 features frame members 72a and 72b and 74a and 74b with a pair of caster lift wires 76a and 76b running there between. As illustrated in FIGS. 5 and 6, cross wire 36 of cart 10 engages and travels up the caster lift wires 76a and 76b so that the rear casters 20a and 20b are lifted when carts 10 and 70 are nested.

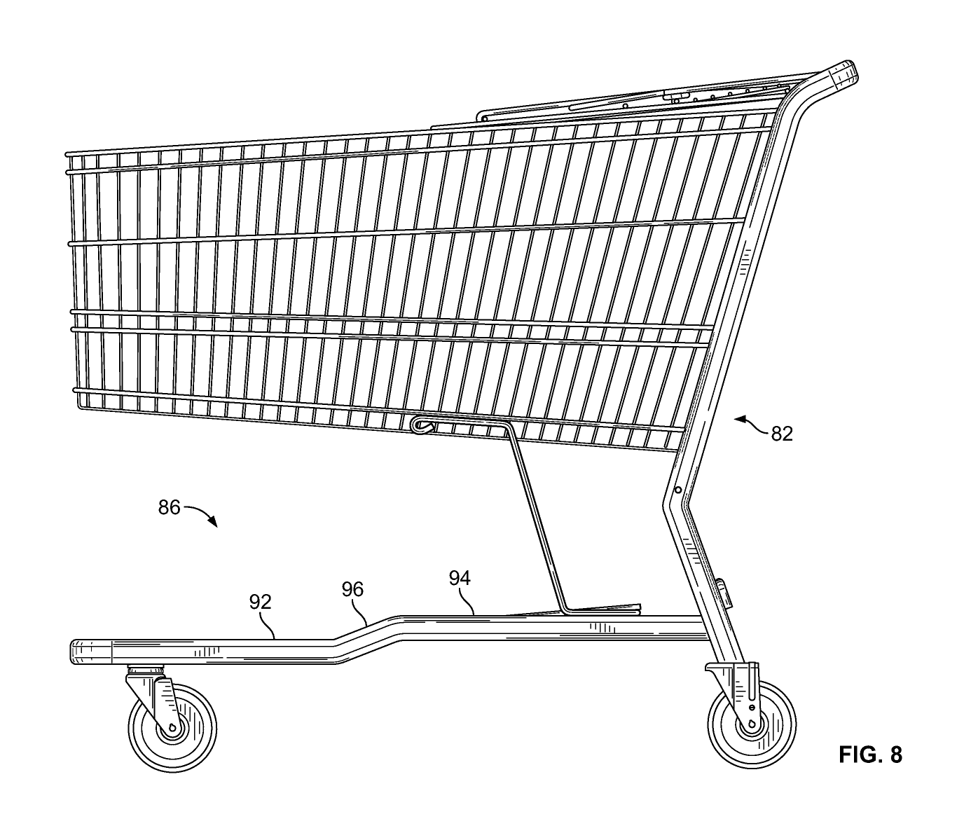

Both the handle 14 and frame 16 of the cart 10 are preferably formed from flat oval tubing, a section of which is indicated at 80 in FIG. 7. The flat oval tubing is preferably made from carbon steel. The orientation of the flat oval tubing provides a “weak bending” direction when forming of the nose 22 of the cart, which facilitates manufacturing.

An alternative embodiment of the shopping cart of the present invention is indicated in general at 82 in FIG. 8 and includes a frame 86 that includes a caster lift having a first tier portion 92, a second tier portion 94 and an inclined portion 96 between the two. This embodiment also preferably uses carbon steel flat oval tubing for the handle and frame.

The construction of the embodiments of the shopping cart of the present invention described above offers savings with regard to materials cost. In addition, the caster lift design is very strong yet economical to produce. Furthermore, the cart is capable of nesting with other carts featuring both similar and dissimilar designs.

While the preferred embodiments of the invention have been shown and described, it will be apparent to those skilled in the art that changes and modifications may be made therein without departing from the spirit of the invention, the scope of which is defined by the appended claims.

What is claimed is:

1. A shopping cart comprising:
a) a handle;
b) a basket attached to the handle;
c) a frame attached to the handle and including opposing sections;
d) each of said opposing sections of said frame including a first tier portion, a second tier portion and an inclined portion positioned between the first and second tier portions so that a caster lift is formed;
e) a plurality of casters attached to the frame.

2. The shopping cart of claim 1 further comprising a cross wire attached to said frame and adopted to engage a caster lift of a second cart.

3. The shopping cart of claim 1 further comprising a cover over the inclined and second tier portions of each of said opposing sections of said frame.

4. The shopping cart of claim 3 wherein the cover is constructed of plastic.

5. The shopping cart of claim 3 wherein the cover is constructed of steel.

6. The shopping cart of claim 1 wherein the handle and frame are made of flat oval tubing.

7. The shopping cart of claim 6 wherein said frame further includes a nose portion connecting the opposing sections and wherein the flat oval tubing of said nose portion of the frame is oriented with a major axis that is generally vertical.

8. The shopping cart of claim 6 wherein the flat oval tubing is carbon steel.

9. The shopping cart of claim 1 wherein the basket features a wire construction.

10. The shopping cart of claim 1 further comprising a pair of supports positioned between the basket and the opposing sections of the frame.

11. The shopping cart of claim 10 wherein the supports are generally Z-shaped.

12. The shopping cart of claim 1 wherein the opposing sections of the frame are arranged to generally form a V-shape.

13. The shopping cart of claim 1 wherein said handle features a generally inverted U-shape.

14. A shopping cart comprising:
a) a handle;
b) a basket attached to the handle;
c) a frame attached to the handle and including first frame section and a second frame section, said first and second frame sections each featuring a leading end and a trailing end;
d) each of said first and second frame sections of said frame including a leading tier portion, a trailing tier portion and an inclined portion positioned between the leading and trailing tier portions so that a caster lift is formed;
e) a plurality of casters attached to the frame.

15. The shopping cart of claim 14 further comprising a cross wire attached between said first and second frame sections to engage a caster lift of a second cart.

16. The shopping cart of claim 14 further comprising a cover over the inclined and second tier portions of each of said opposing sections of said frame.

17. The shopping cart of claim 14 wherein the handle and frame are made of flat oval tubing.

18. The shopping cart of claim 17 wherein said frame further includes a nose portion connecting the first and second frame sections and wherein the flat oval tubing of said nose portion of the frame is oriented with a major axis that is generally vertical.

19. The shopping cart of claim 14 further comprising a pair of generally Z-shaped supports positioned between the basket and the first and second sections of the frame.

20. The shopping cart of claim 14 wherein the first and second sections of the frame are arranged to generally form a V-shape.
